(19) United States
(12) Patent Application Publication
(10) Pub. No.: US 2005/0060319 A1
(43) Pub. Date: Mar. 17, 2005

(54) Method for central planning and distributed control of client roaming and reassociation

(75) Inventors: Bretton Douglas, San Jose, CA (US); Arnold Bilstad, San Jose, CA (US); Timothy Olson, San Jose, CA (US); David Stephenson, San Jose, CA (US); Sheausong Yang, Saratoga, CA (US); Nancy Winget, Mountain View, CA (US); Stuart Norman, Don Mills (CA); Robert Meier, Cuyahoga Falls, OH (US); Douglas A. Smith, Stouffville (CA)

Correspondence Address: TUCKER, ELLIS & WEST LLP, 1150 HUNTINGTON BUILDING, 925 EUCLID AVENUE, CLEVELAND, OH, 44115-1475, US

(73) Assignee: Cisco Technology, Inc.

(21) Appl. No.: 10/957,394

(22) Filed: Oct. 1, 2004

Related U.S. Application Data
(63) Continuation-in-part of application No. 10/837,864, filed on May 3, 2004.
Application No. 10/837,864 is a continuation-in-part of application No. 10/212,193, filed on Aug. 2, 2002.

(51) Int. Cl. G06F 7/00

(52) U.S. Cl. 707/10

(57) ABSTRACT

A technique for network planning that includes an interface for guiding a network user through the network allocation process, such as defining groups of clients based on their capabilities. Portions of the wireless local area network infrastructure, e.g., access points, are allocated among the groups. When a client attempts to associate with an access point, the access point determines the client capabilities. If the client is supported by the access point, the access point allows the client to associate and sends the client a message that contains a prioritized list of other nearby access points allocated to service that client, otherwise the access point sends a prioritized roaming list of nearby access points to the client that are allocated to serve that type of client. Feedback is provided by the network infrastructure enabling a network user or the network to automatically reallocate resources based on the feedback.

### CROSS-REFERENCE TO RELATED APPLICATIONS

This application is a continuation-in-part of U.S. application Ser. No. 10/837,864; filed May 3, 2004. This application is a continuation-in-part of U.S. application Ser. No. 10/212,193 filed Aug. 02, 2002.

### BACKGROUND OF THE INVENTION

The present invention relates generally to wireless networks, and more specifically to planning and distributed control of client roaming on a wireless network.

As the number of uses for wireless LAN's increases, the number of different client capabilities and client applications will continue to increase. From the perspective of the wireless infrastructure, two clients may differ in many different ways including but not limited to:
Roaming clients vs. Stationary clients;
Fast Roaming clients vs. Slow Roaming clients;
Voice Traffic clients vs. Video Traffic clients vs. Data Traffic clients vs. (voice and data, or any combination of the three) traffic clients;
802.11b only Radios vs. 802.11g capable Radios;
Compliance to different proprietary standards (CCX Version 1, 2, 3, and higher Super G, A+/G+, etc.);
802.11 voice clients support only up to 2 Mbps, 802.11b and some support up to 11 Mbps, 802.11a/g clients may support up to 12, 24, 36, or 54 Mbps, and 802.11n clients may support up to 600 Mbps.
Support for 802.11k vs. no support for 802.11k.
Support for 802.11h vs. no support for 802.11h.
Support for 802.11i vs. no support for 802.11i.
Compliance with the 802.11 and 802.11e MAC protocols vs. clients that violate those protocols.
Special features such as precision location tracking capability
   Each of the properties listed above can be thought of as a feature of a client. A feature vector is used to describe the various capabilities of the client, including but not limited to the aforementioned properties. Thus, each client can be described by a “feature vector” associated with its mobility, traffic patterns, standards compliance, proprietary modes and other capabilities.

### BRIEF SUMMARY OF THE INVENTION

The present invention includes methods and systems for central planning and distributed control of client roaming and reassociation for wireless networks.

In accordance with an aspect of the present invention, there is described herein a method for distributed control of a network. The method comprises defining a plurality of groups of client configurations and allocating portions of the network infrastructure to service the groups.

An access point in accord with an aspect of the present invention is disclosed herein. The access point comprising a transmit circuit, a receive circuit, a memory and a controller that comprises a central processing unit (CPU) such as a microprocessor. The transmit circuit is used for transmitting data to clients and the receive circuit for receiving data from clients. The memory is configured to store a list containing at least one feature vector supported by the access point. The controller is communicatively coupled to the transmit and receive circuit and the memory. The controller being configured to receive or determine a client feature vector from a client attempting to associate with the access point via the receive circuit. The controller is further configured to access the memory to retrieve the list to determine whether the feature vector from the client matches a feature vector supported by the access point. If the memory contains a matching feature vector, the control is responsive to allow the client to associate by communicating with the client via the transmit circuit after determining that the feature vector from the client matches a feature vector supported by the access point. If the access point is not configured to support a client with a particular feature vector, it may give the client a roaming list of neighboring APs that are configured to support clients with that feature vector. Another aspect of the present invention is that after the client has successfully authenticated and associated to the access point, the access point will send a protected unicast message with a roaming list of neighboring APs that are also configured to support the client. This unicast message enables the client to minimize roaming time and optimize it's roaming decision by only selecting one of the access points provided in the roaming list.

Another aspect of the present invention is a computer readable medium of instructions. The computer readable medium of instructions comprising means for defining a plurality of groups of client configurations and means for allocating portions of a network infrastructure to service the groups. A computer-readable medium is any article of manufacture that contains data that can be read by a computer or a carrier wave signal carrying data that can be read by a computer. For example, the means for defining a plurality of groups of client configurations and means for allocating portions of a network infrastructure to service the groups may be distributed on magnetic media such as a floppy disk, flexible disk, hard disk, reel-to-reel tape, cartridge tape and cassette tape; optical media, such as a CD-ROM, DVD and writeable compact disk; or on a carrier wave signal received through a network, wireless network, or modem including radio-frequency signals and infrared signals.

A feature of the present invention is that it enables network operators to move classes of clients, e.g., voice clients or fast roaming clients, to umbrella cells in order to minimize disruptions associated with roaming. The present invention allows for different treatment for different classes of clients, lessening the impact of poor performing clients from disrupting network performance or greedy clients expecting to usurp network bandwidth. Furthermore, the present invention enables portions of the network infrastructure to be dedicated to legacy clients and to optimize the performance of the remainder of the infrastructure.

The present invention enables a set of client features to be defined as a feature vector and enables a wireless network administrator to treat clients with different feature vectors differently. Some examples are:
designating a network of microcells for high network throughput and umbrella cells for fast roaming and voice clients.
separating the voice traffic, video traffic and data traffic onto different channels to the maximum extent possible.
reserving certain 2.4 GHz channels for b-only radios and set aside others for g-capable radios.
separating clients that support a particular 802.11 standard, such as 802.11k, 802.11h, or 802.11i, from clients that do support those standards.
keeping clients that don't support a particular proprietary standard off a particular channel or particular set of access points in order to maximize the performance of the clients that do support that standard.
separating clients that support different security policies.

Still other objects of the present invention will become readily apparent to those skilled in this art from the following description wherein there is shown and described a preferred embodiment of this invention, simply by way of illustration of one of the best modes best suited for to carry out the invention. As it will be realized, the invention is capable of other embodiments and several details are capable of modifications in various obvious aspects. Accordingly, the drawing and descriptions will be regarded as illustrative in nature and not as restrictive.

### BRIEF DESCRIPTION OF THE SEVERAL VIEWS OF THE DRAWING

The accompanying drawings incorporated in and forming a part of the specification, illustrates several aspects of the present invention, and together with the description serve to explain the principles of the invention.

FIG. 1 is a block diagram of a network in accordance with an aspect of the present invention.

FIG. 2 is a functional block diagram for configuring a wireless network in accordance with an aspect of the present invention.

FIG. 3 is a block diagram of a method for assigning access points to groups of clients within a wireless network in accordance with an aspect of the present invention.

FIG. 4 is a block diagram of modules for implementing methodologies of the present invention.

FIG. 5 is a block diagram of a method for associating a client with an access point in accordance with an aspect of the present invention.

FIG. 6 is a block diagram of an access point configured in accordance with the present invention.

### DETAILED DESCRIPTION OF INVENTION

Throughout this description, the preferred embodiment and examples shown should be considered as exemplars, rather than limitations, of the present invention. Various aspects of the present invention correspond to several different components for central planning of a wireless network and distributed control of client roaming and reassocation.

An aspect of the present invention is network planning software that can provide a network administrator or operator with the ability to differentiate clients and with the ability to define policies for how to handle the different types of clients. The software can provide guidance or employ a “Wizard” to guide the administrator or operator through the process. The different types of client configurations are grouped by features. The groups of client configurations comprise mobility, traffic patterns, standards compliance and capabilities for the clients belonging to the groups. The features of each group being defined as a feature vector or other data structure. Client configurations specify at least one of the following: whether the client is roaming or stationary, whether the client is a fast roaming or slow roaming client, whether the client is a voice client, video client and/or a data client, whether the client is one or more of an 802.11b compliant client, an 802.11a compliant client, an 802.11g compliant client, an 802.11k compliant client, an 802.11h compliant or an 802.11i compliant client, the client's throughput rate(s), and any Quality of Service (QoS) parameters.

A “feature vector” is used to define the communication characteristics of members of the group. When a client authenticates or associates with an access point, the access point determines the client's communication parameters and thus maps the client to a specific “feature vector”.

Another aspect of the present invention is that the network planning software can take the defined policies and information available to the network planning software regarding access point (AP) locations, the space to be covered by the wireless local area network (WLAN) and the radio frequency (RF) propagation characteristics of the area being covered and derive a plan for each access point that the network planning software manages. The plan can include frequency, transmit power, and client service parameters. Each access point can be assigned to serve a certain number of clients with a certain set of feature vectors. Furthermore, the assignment of access points to feature vectors is propagated throughout the network so that any access point on the network can determine which access points serve a certain feature vector. The assignment of access points to feature vectors can be stored at a central repository available to the access points, or can be propagated to the access points, wherein the access points store the information in local memory.

In accordance with another aspect of the present invention, when a client attempts to associate to an access point, the access point determines the feature vector for the client. If the access point has been assigned or configured to serve the feature vector sent by the client, the access point will let the client associate. The access point will send a unicast message to the client that contains a prioritized roaming list of other nearby access points allocated to serve the feature vector for that client. If the feature vector is not a feature vector that the access point has been assigned to serve, then the access point will send a unicast message to the client that consists of a prioritized roaming list of nearby access points allocated to that type of client. The access point can send this message as part of the attempted association process, or the access point can allow the client to associate, send the message, and then disassociate the client. The information contained in the unicast message can reside on the access point or can be obtained from another component of the network such as a central server. To ensure best security practices, it is highly recommended that the client authenticate so that the message containing the list of nearby access points is protected from both eavesdropping and forgery. Additionally, even when the client has successfully associated and authenticated to the access point, the access point will also send the list of nearby access points allocated to that client (mapping to the “feature vector”) to minimize the delays incurred by the client when deciding where to roam to next.

In accordance with an aspect of the present invention, when the client decides to roam, e.g., because of a weak signal or an overloaded cell, fails to associate with an access point or is disassociated, the client uses the roaming list of access points that was transmitted during the association process for selecting another access point. The client can passively or actively scan through the roaming list to determine which access point to associate with, or if the client cannot associate with any access point in the roaming list, the client can switch to a generic roaming protocol. The client will receive a new roaming list after associating with a new access point.

Another aspect of the present invention includes providing feedback to the network administrator or operator describing the number of clients for each type of client being served by the network, their traffic load, and the loading at each access point. This provides guidance to the administrator or operator for re-allocating the network infrastructure as the client distribution changes over time. Alternatively, the network planning software can include modules that monitor and automatically reallocate network resources as the client distribution changes over time.

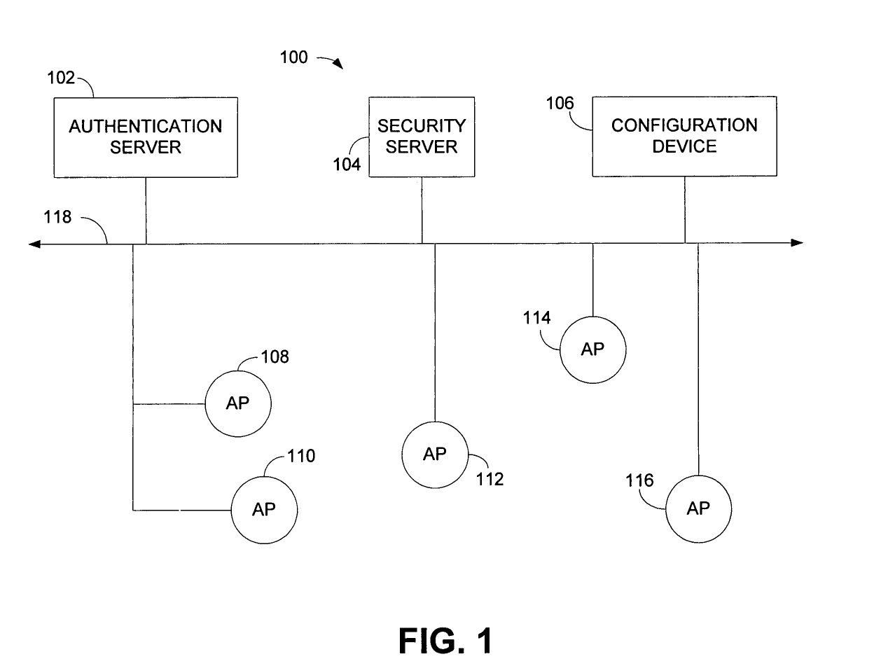

FIG. 1 is a block diagram of a wireless network 100 in accordance with an aspect of the present invention. Network 100 comprises a plurality of access points 108, 110, 112, 114 and 116 that are connected together by a backbone network 118. Backbone network 118 can be any wired, wireless, or combination of wired and wireless network topologies. Backbone network 118 enables access points 108, 110, 112, 114 and 116 to communicate with each other and with authentication server 102, security server 104 and configuration device 106.

Authentication server 102 is for authenticating clients attempting to communicate with wireless network 100. Security server 104 manages security issues, such as key exchanges, with clients. For example once a client has been authenticated, security server 104 sends the client's appropriate keying material to the associated access point. Additionally, security server 104 sends keying material as required to neighboring access points to facilitate fast roaming.

In accordance with an aspect of the invention, configuration device 106 is employed to configure the various components of wireless network 100. Configuration device 106 has logic, either embodied in hardware, software, or a combination of hardware and software to define operational parameters of the network. As shown, configuration device 106, security server 104, and authentication server 102 are separate standalone components, however, any two or more of these components 102, 104, 106 or access points 108, 110, 112, 114, 116 can be combined.

In accord with an aspect of the present invention, configuration device 106 has logic for defining a plurality of groups of client configurations. Each group of client configurations is assigned a feature vector. Configuration device 106 also has logic for allocating portions of the network infrastructure to service the groups.

In accordance with an aspect of the present invention, configuration device 106 allocates portions of the network infrastructure by assigning an access point to each group of client configurations or feature vector.

Configuration device 106 communicates with access points 108, 110, 112, 114 and 116 to configure the access point 108, 110, 112, 114 and 116 to be responsive to an assigned group, such as clients having a defined feature vector, to allow a client belonging to the assigned group to associate with the access point. Configuration device 106 further configures access points 108, 110, 112, 114 and 116 to send a list of access points allocated to service the group that the associated client belongs. Furthermore, the configuration device 106, having knowledge of the location of access points 108, 110, 112, 114 and 116, provides each access point 108, 110, 112, 114, 116 the list of neighboring APs. The provided information enables access points 108, 110, 112, 114, 116 to further report to each client, upon association, a prioritized list of neighboring access points.

For clients that do not belong to a group serviced by an access point, e.g., access points 108, 110, 112, 114 and 116, configuration device 106 configures access points 108, 110, 112, 114 and 116 to send to the client a list of access points that are assigned to provide service for the client's configurations. Lists of access points servicing each client configuration (feature vector) can be maintained at each access point, in the configuration device, or at a central repository elsewhere on the network 100.

An aspect of the present invention is that it enables a roaming client to scan other channels using a prioritized roaming list. The list can be prioritized based on location of the client, received signal strength (RSSI), proximity of the client, channel throughput, error rates, or any desired parameter. Scanning through the priority list reduces scan overhead and optimizes access point selection time. If an access point on the scanning list with an acceptable signal cannot be found, the client would then employ a generic scanning algorithm.

An aspect of the present invention is that it enables certain client configurations to be assigned to umbrella cells. Umbrella cells are cells that are found in high density architectures and provide an overlap in coverage with one or more other cells. For example, an umbrella cell can have an access point setup to serve QoS or fast roaming clients while other access points within the same cell area as the umbrella cell serve slower roaming clients. This technique can minimize disruptions caused by poor performing clients.

For example, access point 112 can be configured as an umbrella cell that overlaps the coverage areas of cells serviced by access points 108, 110, 114 and 116. Thus, when a fast roaming or QoS client moves into a cell served by access points 108, 110, 114 or 116, the client associates with access point 112, while slower clients are served by access points 108, 110, 114 and 116. If a fast roaming or QoS client attempts to associate with access points 108, 110, 114 or 116, the client will receive a roaming list that includes access point 112 or any other access point configured to service the client's feature vector. Similarly, if a slow roaming client attempts to associate with access point 112, access point 112 sends the client a roaming list containing access points 108, 110, 114 or 116.

Another aspect of the present invention is that the present invention can enable a network administrator or operator to allocate a portion of the wireless network 100 infrastructure to legacy clients and optimize the performance of the remainder of the infrastructure. For example, one or more access points can be assigned to service legacy clients while the remaining access points are assigned to upgraded clients. For example, access points 110 and 114 can be assigned to legacy clients, while access points 108, 112 and 116 can be assigned to other clients. When a client roams into a cell covered by access points 108, 110, 112, 114 and 116, if it is a legacy client it will associate with either access point 110 or 114, otherwise it will associate with either access point 108, 112 or 116.

In accordance with another aspect of the present invention configuration device 106 receives operational data from other components of network 100 on backbone 118. For example, one or more of authentication server 102, security server 104, and access points 108, 110, 112, 114 and 116 are suitably adapted to send operational data to configuration device 106. The operational data including but not limited to at least one of types of client being served and by which access points, the number of each type of client being served and by which access point, traffic load, loading on each access point, and channel capacity. This enables a network administrator or operator to effectively monitor the network 100 and change the allocation of network resources proactively. Furthermore, configuration device 106 can include logic for generating an alarm when the load on the network or channel capacity of any channel exceeds a predetermined threshold. The alarms can be generated visually, and/or audibly. Furthermore, the alarms can be stored at configuration device 106 for subsequent review and to maintain a history.

Another aspect is network load balancing. An access point, e.g., access points 108, 110, 112, 114 and 116, may independently determine when its load capacity threshold is exceeded and thus determine which clients to request to roam. Additionally, each AP 108, 110, 112, 114, 116 reports its load to the configuration device 106 as well as when it believes its capacity is about to be exceeded. The configuration device 106 may trigger clients to initiate roams based on the feature vectors, signal strength and/or location but is not limited to those parameters). The capacity thresholds and parameters for roaming determination can be configurable.

Although the embodiment shown in FIG. 1 has five access points 108, 110, 112, 114 and 116, those skilled in the art can appreciate the present invention can be adapted to a network with a single access point, or any number of access points.

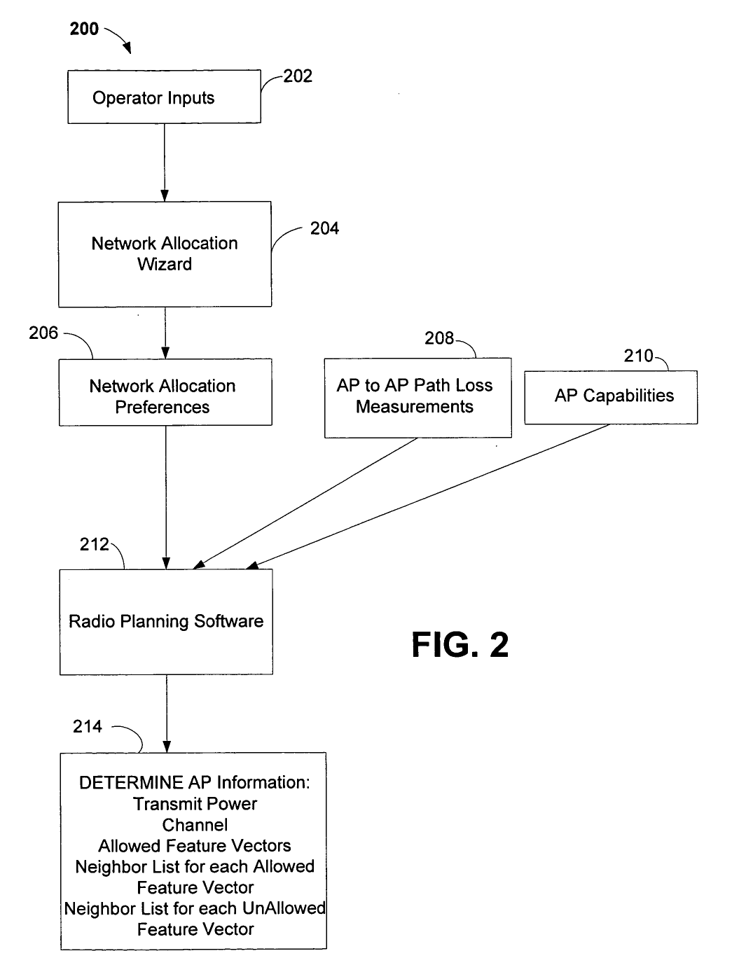

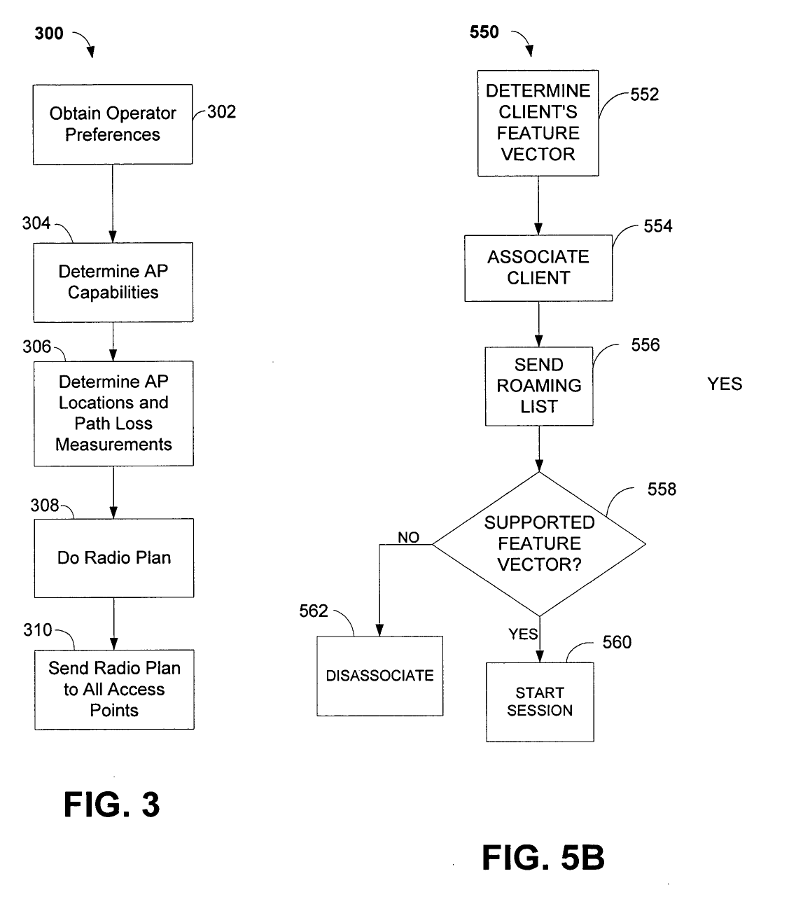

In view of the foregoing structural and functional features described above, methodologies in accordance with various aspects of the present invention will be better appreciated with reference to FIGS. 2 and 3. While, for purposes of simplicity of explanation, the methodologies of FIGS. 2 and 3 are shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 2 is a functional diagram 200 for configuring a network, such as network 100 in FIG. 1, in accordance with an aspect of the present invention. Operator inputs 202 are received by a network allocation wizard 204 for obtaining network allocation preferences 206 configuring the network. The network allocation preferences 206 received via operator inputs 202 by network allocation wizard 204 could include, but are not limited to, 1) breakdown of 802.11a, 802.11b to 802.11g clients; 2) the extent it is desired to split 802.11a, 802.11b and 802.11g traffic; 3) the extent it is desired to split 802.11i and 802.11n traffic; and 4) if umbrella cells are desired for fast roaming. Radio Planning Software 202 receives the network allocation preferences 206 as well as AP to AP path loss measurements 208 and AP capabilities which are determined by other processes on the network. The Network planning software 212 determines AP Information 214 based on the network allocation preferences 206, AP to AP path loss measurements 208 and AP capabilities 210. AP information 214 may include, but is not limited to, transmit power, channel, allowed feature vectors, neighbor list for each allowed feature vector, neighbor list for each unhallowed feature vector. AP information 214 is generated and sent to each AP being managed.

FIG. 3 is a block diagram of a method 300 for configuring access points within a wireless network in accordance with an aspect of the present invention. At 302, operator preferences for the network are obtained. The preferences ordinarily would be obtained via an interface generated by software. The operator would be presented with fields that obtain desired operating parameters for the network. At 304 the capabilities of each AP being managed on the wireless network are obtained. The capabilities would include whether the AP is stationary or roaming, and the types of client's the AP is capable of supporting. At 306, the locations of each AP and the path loss measurements are obtained. At 308 a radio plan is created based on the operator preferences, AP capabilities, AP locations and path loss measurements obtained at 302, 304 and 306 respectively. The plan would determine, for each AP, transmit power, channel, allowed feature vectors, and neighbor lists for each feature vector, whether the feature vector is allowed or not. At 310, the plan is sent to the access points.

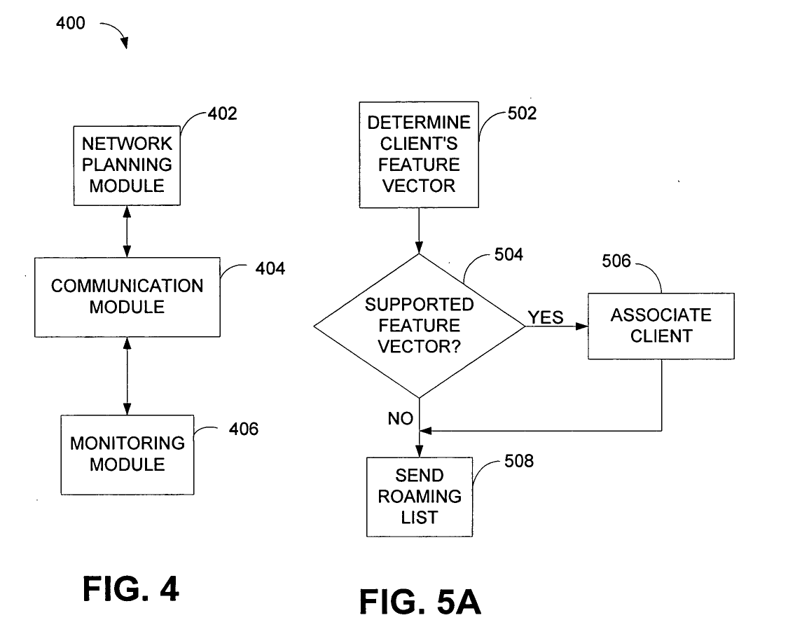

FIG. 4 is an exemplary block diagram of modules of a configuration device 400 for implementing methodologies of the present invention. The modules are comprised of logic (computer readable instructions) that can be implemented in either hardware, software or a combination of hardware and software. The modules include a network planning module 402, a communication module 404 and a monitoring module 406. These modules may be implemented on a single computer system or distributed among a plurality of computer systems.

Network planning module 402 includes computer readable instructions for defining a plurality of groups of client configurations. The groups of client configurations comprise mobility, traffic patterns, standards compliance and capabilities for the clients belonging to the groups as previously defined herein. Network planning module 402 also has computer readable instructions for allocating portions of a network infrastructure to service the groups. The instructions can include a visual display, for example a map, of components in the network to allow a network administrator or operator to select operating parameters such as 1) breakdown of clients, such as 802.11b to 802.11g clients; 2) to what extent to split traffic between various protocols, e.g., 802.11b to 802.11g traffic, or 802.11i to 802.11n traffic; 3) should umbrella cells by provided for fast roaming. Network planning module 402 further includes computer readable instructions for assigning an access point to each group of client configuration.

In accordance with an aspect of the present invention, network planning module 402 also has computer readable instructions for configuring an access point to be responsive to an assigned group to allow a client belonging to the group to associate with the access point. For example, when a client attempts to associate with an access point, the access point determines group membership for the client. The access point will most likely gather that information during the association process before determining the feature vector or group for the client. However, in the alternative, the client can send the desired communications parameters, such as a feature vector to the access point during the association process. The access point can be configured to associate or reject an association attempt of a client based on the client's group membership as well as the network load the client may impose on that access point.

In accordance with an aspect of the present invention, network planning module 402 also has computer readable instructions for configuring an access point to send a list of access points allocated to service the groups a client belongs to. The instructions can either send a list of access points that service the group to the client, which can store the information in local memory, or the instructions can inform the client the location of a repository, e.g., a central repository, from where the client can obtain the list. The AP would access the repository to obtain the appropriate neighbor (roaming) list for the client.

In accordance with an aspect of the present invention, network planning module 402 comprises computer readable instructions for propagating the security policy for a client to a neighboring access point that is also assigned to serve the group the client is a member. For example, an access point can be configured to notify a security server to send the client's security context, to neighboring access points on the client's roaming list or the access point can be configured to send the security context to the neighboring access points.

In accordance with an aspect of the present invention, network planning module 402 includes computer readable instructions for configuring an access point to send a list of access points that provide service to a client that is not a member of one of the groups of client configurations serviced by the access point. For example, if a client that belongs to a group that is not serviced by the access point attempts to associate with an access point, the access point rejects the client but sends a list of access points that do service the group. The list may be prioritized based on location of the client, received signal strength, proximity of the client, channel throughput, error rates, or any desired parameter. Alternatively, for better security practices, the access point may allow the client to associate, send the list, and then disassociate the client.

Communication module 404 is used by the configuration device to send configuration data to other components on the network. In addition, communication module 404 receives communications from other network components, including the access points.

Monitoring module 406 monitors the current operating state of the network. Monitoring module receives data from other network components, e.g., access points, via communication module 404. Monitoring module 406 monitors network operational parameters such as types of client being served and by which access points, the number of each type of client being served and by which access point, traffic load, loading on each access point, and channel capacity. Furthermore, monitoring module 406 can include logic for generating an alarm when the load on the network or channel capacity of any channel exceeds a predetermined threshold. The alarms can be generated visually, and/or audibly. Furthermore, the alarms can be stored at monitoring module 406 or network planning module 402 for subsequent review and to maintain a history. In addition, predetermined thresholds can be set to enable the automatic adjustment of the network allocation of APs to serve the client groups based on feedback received from the AP. For example, if 802.11b traffic is light and drops below a threshold value, the percentage of APs dedicated to 802.11b traffic is automatically decreased. The APs formerly dedicated to 802.11b client's are then available to service other client's such as 802.11g clients. Similarly, if the amount of traffic for a particular protocol exceeds a certain value, additional APs can be dedicated to serve that protocol. The predetermined thresholds can also trigger more proactive load balancing of the network by enabling the network planning module to communicate with the APs and enable the access points to direct currently associate clients to roam and/or to reject further associations of clients mapping to particular “feature vectors”. The rejection is subject to further parameter specifications such as (but not limited to) amount of time or capacity threshold.

FIGS. 5A and 5B are block diagrams of methodologies, 500 and 550 respectively, for associating a client with an access point in accordance with an aspect of the present invention. While, for purposes of simplicity of explanation, the methodologies of FIG. 5 are shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

Referring to FIG. 5A, at 502, the access point determines the client's feature vector. The access point can determine the feature vector from probe requests and responses, TSpecs from the client, traffic type from the client, association history of the client, association/authentication information, Media Access Control (MAC) address, from data stored locally at the access point or at another location on the network, e.g., from an authentication server or a domain server, or alternatively the feature vector can be sent by the client with either an authentication or association request.

At 504, the access point determines whether it supports the client's feature vector. The access point is configured to service specified feature vectors. Thus, the access point will accept association requests from clients having a supported feature vector, and reject association requests from clients not having a supported feature vector.

If at 506 the access point determines it supports the client's feature vector (YES), then at 506 the access point allows the client to associate. At 508, the access point sends a roaming list to the client. The roaming list containing a list of neighboring access points that support the client's feature vector. The roaming list is sent by a unicast transmission from the access point to the client.

If at 506 the access point determines it does not support the client's feature vector (NO), at 508 the access point sends a roaming list to the client. The roaming list containing a list of neighboring access points that support the client's feature vector. The roaming list is sent by a unicast transmission from the access point to the client during the association procedure. Alternatively, for better security practices, the access point can allow the client to associate, send the roaming list, and then disassociate the client.

The roaming list of access points that support the client's feature vector sent at 508 can be prioritized. For example, the roaming list can be prioritized based on at least one of path loss, distance to nearby access points, access point loading, received signal strength indication (RSSI), throughput, and error rate.

Referring to FIG. 5B, at 552, the access point determines the client's feature vector. The feature vector may be determined by the techniques described herein with respect to 502 (FIG. 5A).

At 554 the access point allows the client to associate. At 556, the access point sends a roaming list to the client. The roaming list containing a list of neighboring access points that support the client's feature vector. The roaming list is sent by a unicast transmission from the access point to the client. The roaming list of access points that support the client's feature vector sent at 556 can be prioritized. For example, the roaming list can be prioritized based on at least one of path loss, distance to nearby access points, access point loading, received signal strength indication (RSSI), throughput, and error rate.

If at 558 the access point determines whether supports the client's feature vector. if at 558 it is determined that the access point supports the client's feature vector (YES), then at 560 the session with the client is established; otherwise (NO) at 562 the access point disassociates the client, or suggests that the client roam, or otherwise force the client to roam.

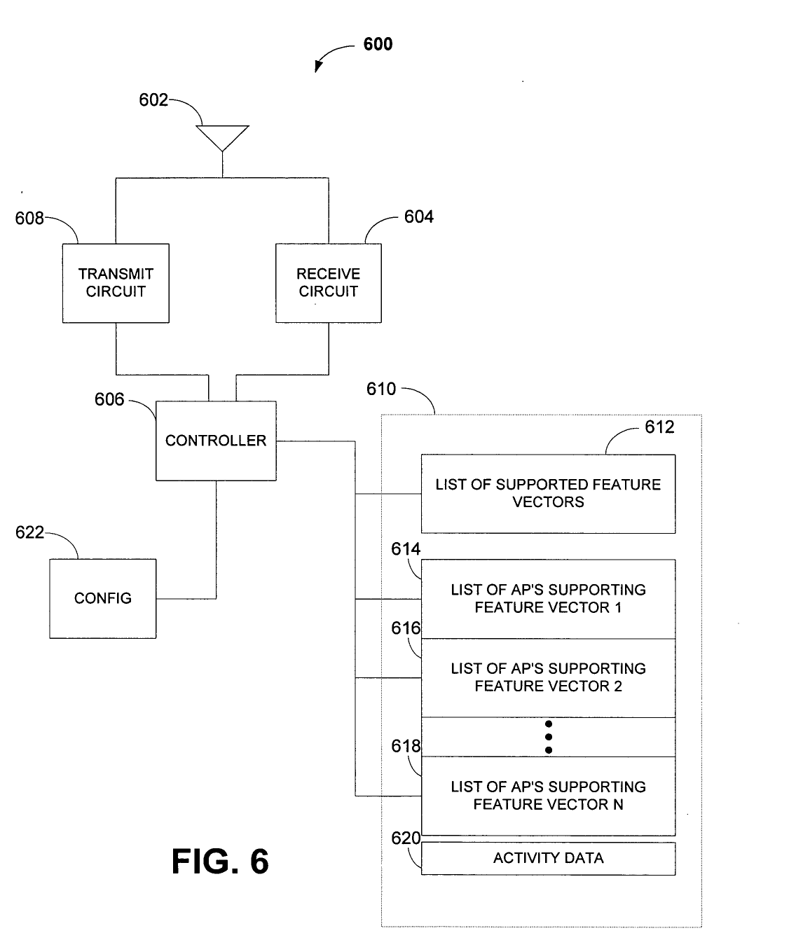

FIG. 6 is a block diagram of an access point 600 configured in accordance with the present invention. Access point 600 receives messages via antenna 602 which are routed through receive circuit 604. Messages are transmitted by transmit circuit 608 via antenna 602. Controller 606 controls the operation of receive circuit 604 and transmit circuit 608. Controller 606 comprises logic embodied either in software, hardware, or a combination of software and hardware. Controller 606 is coupled to memory 610. Memory 610 can be local to the access point or located elsewhere on the network at a location that is accessible to controller 606. Config 624 is coupled to controller 606 via backbone connection 624 and is used to configure controller 606. Config 622 can be located at access point 600 or be remotely located. Config 622 is used to specify to controller 606 which feature vectors to support. Controller 606 stores the configuration information in memory 610. Backbone connection 624 is the connection used by access point 600 to communicate with other components on the network such as authentication servers (not shown) or domain servers (not shown).

Within memory 612 is a region containing a list of supported feature vectors 612, which specifies the feature vectors access point 600 supports. Another region of memory 610 contains a list of access points that support a first feature vector 614. Another region of memory 610 contains a list of access points that support a second feature vector 616. Additional regions of memory 610 are allocated to support additional feature vectors, including the region of memory 610 containing a list of access points supporting feature vector N 618, where N is an integer greater than 2. The activity data region 620 of memory 610 stores activity data for access point 600. The data stored in activity data region 620 includes at least one of types of client being served, the number of each type of client being served, traffic load, and channel capacity.

When a client desires to associate with access point 600, it sends an association request that is received via antenna 602, processed by receive circuit 604, and forwarded to controller 606. Controller 606 determines the feature vector for the client. There are several methods which the controller 606 can use to determine the feature vector. For example, the controller can observe probe request and probe response behavior, obtain the client's TSpecs, observe traffic type from the client, the association history of the client, association and/or authentication information, and/or from the client's MAC address. Alternatively, the feature vector may be specified in the association request, or the controller can determine it during the association process, or controller 606 can determine the address from memory 610 or from a remote location via backbone connection 624. Controller 606 determines whether access point 600 supports the client's feature vector by accessing the region of memory 610 containing the list of supported feature vectors 612 to ascertain whether there is a match for the client's feature vector. If there is a match, then controller 606 creates an association response that is routed to transmitter 608 to be transmitted to the client.

Controller 606, is also configured to search regions 614, 616, 618 to for a list of access points that support the feature vector for the client. After locating the appropriate list, controller 606 creates a unicast message that is sent by transmit circuit 608 to the client containing the list of access points that support the client's feature vector. If the client has a feature vector that is not supported by access point 600, controller 606 can still send a unicast message, or alternatively, can associate the client by sending an association response message, the roaming list, and a disassociation message through transmit circuit 606. The roaming list can contain a list of all access points supporting the client's feature vector, a list of neighboring access points, or be prioritized based on at least one of path loss, distance to nearby access points, access point loading, and received signal strength indication.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims interpreted in accordance with the breadth to which they are fairly, legally and equitably entitled.

1. A method for distributed control of a network, comprising:
defining a plurality of groups of client configurations; and
allocating portions of the network infrastructure to service the groups.

2. The method of claim 1, the allocating portions of the network infrastructure further comprising assigning an access point to each group of client configurations.

3. The method of claim 1, the allocating portions of the network infrastructure further comprising:
configuring an access point to be responsive to a one of the plurality of groups of client configurations to allow a client belonging to the one of the plurality of groups to associate with the access point.

4. The method of claim 3, the configuring an access point further comprises:
configuring the access point to securely send a list of access points allocated to service the one of the plurality of groups the client belongs.

5. The method of claim 4, further comprising prioritizing the list of access points to limit the list to include only other access points that are near one of the client and the access point that the client is attempting to associate to.

6. The method of claim 3, further comprising propagating one of the security policy and security context for the client to a neighboring access point, wherein the neighboring access point is responsive to the one of the plurality of groups of client configurations.

7. The method of claim 1, the allocating portions of the network infrastructure further comprising:
configuring an access point to service a one of the groups of client configurations;
configuring the access point to send a list of access points that provide service to a client that is not a member of the one of the groups of client configurations.

8. The method of claim 1, wherein the groups of client configurations comprise mobility, traffic patterns, standards compliance and capabilities.

9. The method of claim 8, wherein the client configurations specifies at least one of roaming client, stationary client, fast roaming client, slow roaming client, voice client, video client, data client, 802.11a compliant client, 802.11b compliant client, 802.11g compliant client, client throughput rate, 802.11k compliant, 802.11h compliant, compliant with the 802.11 and 802.11e MAC protocols, and 802.11i compliant

10. A method for an access point to selectively associate clients, comprising:
determining a feature vector of a client attempting to associate with the access point;
associating the client when the feature vector of the client is a supported feature vector by the access point.

11. The method of claim 10, further comprising sending a protected roaming list of access points to the client that support the feature vector of the client.

12. The method of claim 11, wherein the roaming list is prioritized.

13. The method the claim 12, further comprising prioritizing the roaming list based on at least one of path loss, distance to nearby access points, access point loading, and received signal strength indication.

14. The method of claim 10, wherein the feature vector specifies at least one of roaming client, stationary client, fast roaming client, slow roaming client, voice client, video client, data client, 802.11a compliant client, 802.11b compliant client, 802.11g compliant client, client throughput, type of modulation, 802.11k compliant, 802.11h compliant, compliant with the 802.11 and 802.11e MAC protocols, and 802.11i compliant

15. An access point, comprising:
a transmit circuit;
a receive circuit;
a memory configured to store a list containing at least one feature vector supported by the access point; and
a controller communicatively coupled to the transmit circuit, the receive circuit, and the memory, wherein
the controller is configured to determine a client feature vector from a client attempting to associate with the access point via the receive circuit,
the controller is further configured to access the memory to retrieve the list to determine whether the feature vector from the client matches a feature vector supported by the access point, and
the controller is responsive to allow the client to associate by communicating with the client via the transmit circuit after determining that the feature vector from the client matches a feature vector supported by the access point.

16. The access point of claim 15, the controller is further responsive to sending a protected roaming list of access points to the client that support the feature vector of the client.

17. The access point of claim 16, wherein the roaming list is prioritized.

18. The access point of claim 17, further comprising prioritizing the roaming list based on at least one of path loss, distance to nearby access points, access point loading, and received signal strength indication.

19. The access point of claim 15, wherein the the list is encrypted and integrity protected.

20. The access point of claim 15, the controller being further responsive to
obtaining a roaming list of access points that support the client feature vector from the memory; and
sending the roaming list to the client via the transmit circuit;
wherein the client feature vector is not a feature vector supported by the access point

21. The access point of claim 20, wherein the the list is encrypted and integrity protected.

22. A computer readable medium of instructions, comprising:
means for defining a plurality of groups of client configurations; and
means for allocating portions of a network infrastructure to service the groups responsive to the means for defining a plurality of groups of client configurations;
wherein the groups of client configurations are at least one of mobility, traffic patterns, standards compliance and client capabilities.

23. The computer readable medium of instructions of claim 22, the means for allocating portions of the network infrastructure further comprising:
means for assigning an access point to each group of client configuration.

24. The computer readable medium of instructions of claim 22, the means for allocating portions of the network infrastructure further comprising:
means for configuring an access point to be responsive to a one of the plurality of groups of client configurations to allow a client belonging to the one of the plurality of groups to associate with the access point.

25. The computer readable medium of instructions of claim 24, the means for configuring an access point further comprises:
means for configuring the access point to send a list of access points allocated to service the one of the plurality of groups the client belongs.

26. The computer readable medium of instructions of claim 22, further comprising means for propagating an encryption key for the client to a neighboring access point, wherein the neighboring access point is responsive to the one of the plurality of groups of client configurations.

27. The computer readable medium of instructions of claim 22, the means for allocating portions of the network infrastructure further comprising:
means for configuring an access point to service at least one of the groups of client configurations; and
means for configuring the access point to send a list of access points that provide service to a client that is not a member of the one of the groups of client configurations;

28. The computer readable medium of instructions of claim 22, wherein the client configurations specifies at least one of roaming client, stationary client, fast roaming client, slow roaming client, voice client, data client, 802.11b compliant client, 802.11g compliant client, client throughput rate, 802.11k compliant, 802.11h compliant, compliant with the 802.11 and 802.11e MAC protocols, 802.11i compliant, CCX Version 1, 2, 3, 4 compliant, Super G compliant, and A+/G+ compliant.

29. The computer readable medium of instructions of claim 22, further comprising:
means for receiving operational data from the network infrastructure, the operational data including at least one of type of client being served, number of each type of client being served, traffic load, loading on each access point, and channel capacity.

30. The computer readable instructions of claim 28, further comprising:
means for setting a predetermined threshold; and
means for generating an alarm responsive to the means for receiving operational data when a specified condition passes the predetermined threshold.

31. The computer readable medium of instructions of claim 28, further comprising
means for setting a predetermined threshold; and
the means for allocating portions of a network infrastructure responsive to the means for setting a predetermined threshold to reallocate portions of the network infrastructure when a specified condition passes a threshold condition.
